(19) United States
(12) Patent Application Publication
(10) Pub. No.: US 2009/0193470 A1
(43) Pub. Date: Jul. 30, 2009

(54) DATA PROCESSING METHOD, TV DATA DISPLAYING METHOD AND SYSTEM THEREOF

(76) Inventor: Hung-Chi Huang, Taichung City (TW)

Correspondence Address: NORTH AMERICA INTELLECTUAL PROPERTY CORPORATION, P.O. BOX 506, MERRIFIELD, VA, 22116, US

(21) Appl. No.: 12/340,736

(22) Filed: Dec. 21, 2008

(30) Foreign Application Priority Data
Jan. 25, 2008 (TW) 097102808

(51) Int. Cl. H04N 5/445

(52) U.S. Cl. 725/58

(57) ABSTRACT

A data processing method, including: (a) respectively recording usage duration of a plurality of data in a predetermined time period of at least one day to generate a usage time parameter, or respectively recording the number of usage times of a plurality of data in a predetermined time period of at least one day to generate a usage times parameter; and (b) processing the data according to the usage time parameter or the usage times parameter when the data is processed in the predetermined time period of any one day.

### BACKGROUND OF THE INVENTION

1. Field of the Invention

The present invention relates to a data processing method, a TV data displaying method and related systems thereof, and particularly, to a data processing method, a TV data displaying method that can record the usage times, or the usage time and related systems thereof.

2. Description of the Prior Art

A conventional TV system does not compute and record the number of times of display or the display time of TV data. Therefore, a user may find it inconvenient that TV channels to be watched must first be selected each time he or she wishes to watch TV.

Besides, since the amount of TV channels grows day by day, the user may easily forget the channel number of the TV data he wishes to watch, such that the program desired may be hard to find.

Therefore, a new method is needed to solve the above-mentioned problems.

### SUMMARY OF THE INVENTION

Accordingly, one objective of the present invention is to provide a data processing method that can record the usage duration, and a related system thereof, such that the data, e.g., TV data can be processed according to the recorded usage duration.

Another objective of the present invention is to provide a data processing method that can record the number of usage times, and a related system thereof, such that the data can be processed or a selecting interface for selecting the data to be processed can be provided according to the number of usage times of the TV data.

One embodiment of the present invention discloses a data processing method, which comprises: (a) respectively recording usage duration of a plurality of data in a predetermined time period of at least one day to generate a usage time parameter, or respectively recording the number of usage times of a plurality of data in a predetermined time period of at least one day to generate a usage times parameter; and (b) processing the data according to the usage time parameter or the usage times parameter when the data is processed in the predetermined time period of any one day.

Another embodiment of the present invention discloses a data processing method, which comprises: (a) respectively recording the number of usage times of a plurality of data at a predetermined time point in at least one day to generate a usage times parameter; (b) processing the data according to the usage times parameter when the data is processed at the predetermined time point of any one day.

Another embodiment of the present invention discloses a data processing system, which comprises: a data providing module, for providing a plurality of data; a storage device, for storing a usage time parameter or a usage times parameter; and a processing unit, coupled to the data providing module and the storage device, for processing the data, for performing at least one step of: recording usage duration of the data in a predetermined time period of at least one day to generate a usage time parameter; recording the numbers of usage times of a plurality of data in a predetermined time period of at least one day to generate a usage times parameter; and for processing the data according to the usage time parameter or the usage times parameter when processing the data in the predetermined time period of any one day.

According to above-mentioned embodiments, the data can be automatically processed or a selecting interface can be provided, and thereby the convenience of the user can be enhanced.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a TV data displaying method according to a first embodiment of the present invention;

FIG. 2 illustrates a TV data displaying method according to a second embodiment of the present invention;

FIG. 3 illustrates a flowchart that includes both of the steps of the first embodiment and the second embodiment; and

FIG. 4 illustrates a system corresponding to the first embodiment and the second embodiment of the present invention.

### DETAILED DESCRIPTION

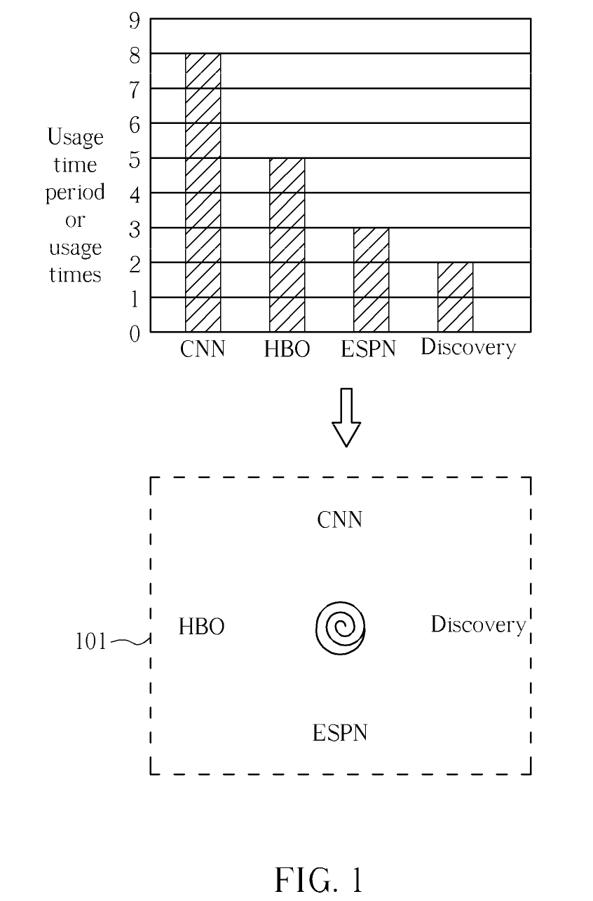

FIG. 1 illustrates a TV data displaying method according to a first embodiment of the present invention, which can be named as the “selecting interface mode” or “My Favorite mode”. As shown in FIG. 1, the number of usage times of the channels can be computed to generate a usage times parameter. Alternatively, the usage duration of the channels can be computed to generate a usage time parameter, and the two parameters can then be recorded. Then a selecting interface 101 for selecting a channel to be displayed is provided according to the usage time parameter and/or the usage times parameter. In this embodiment, the selecting interface 101 displays four channels that have the maximum number of displaying times or usage duration, but this is not meant to limit the scope of the present invention.

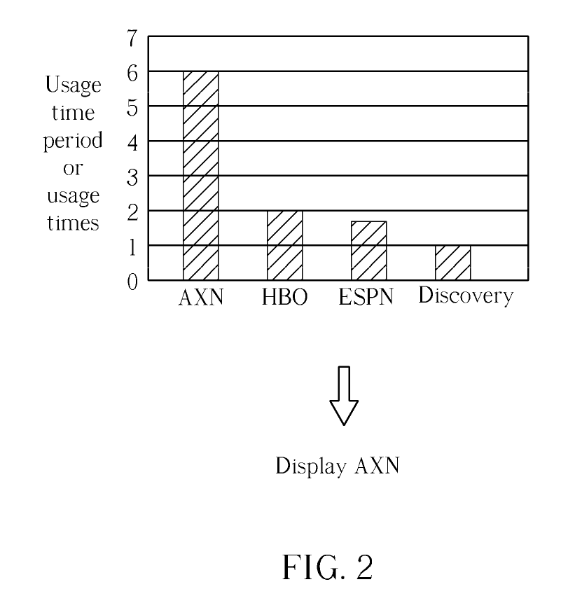

FIG. 2 illustrates a TV data displaying method according to a second embodiment of the present invention, which is also called a time mode. In this mode, the TV data displaying method according to a second embodiment of the present invention computes the usage duration or usage times of a plurality of data in a predetermined time period (e.g., 19:00˜21:00) of at least one day to generate a usage time parameter and/or a usage times parameter. Then, the method displays the TV data according to the usage time parameter or the usage times parameter when the TV data is displayed in the predetermined time period of any one day. In this embodiment, the usage time parameter or the usage times parameter is generated according to channel information of the TV data, such that the channel can be switched accordingly.

In this embodiment, if the channel having the maximum usage duration or maximum usage times for the time interval 19:00˜21:00 is the AXN channel, then the AXN channel is displayed in the time interval 19:00˜21:00. The display method can be either automatically switching to the AXN channel when turning on the TV, or setting a predetermined time point to automatically switch to the AXN channel when the time reaches the predetermined time point.

Alternatively, the method shown in FIG. 2 can be computing the number of usage times of a specific channel at a predetermined time point, e.g., 19:00, and switching to a channel with the maximum usage times at 19:00. Further, in principle, the method in FIG. 2 can be implemented to data other than TV data, such as music data and movie data.

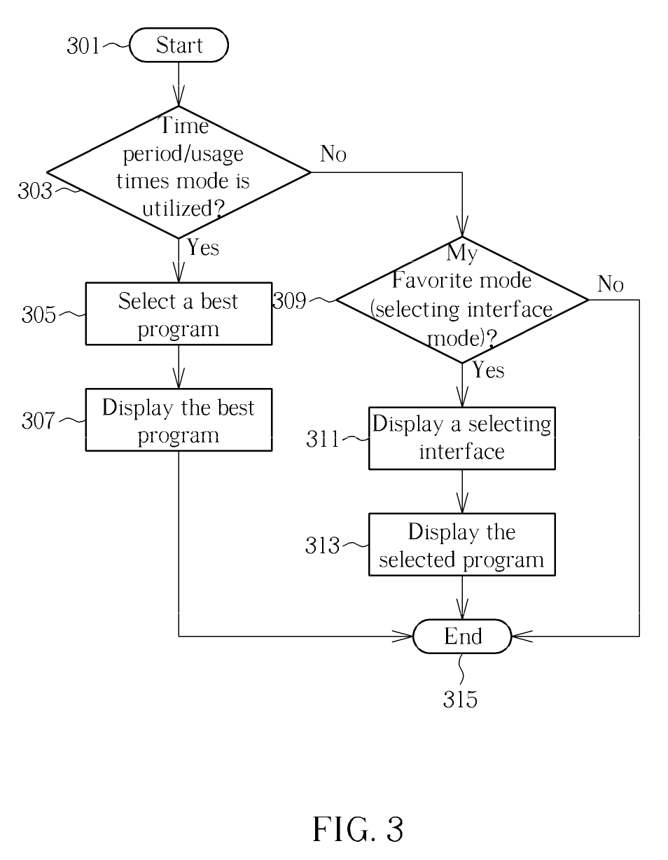

FIG. 3 illustrates a flowchart that includes steps of both the first embodiment and the second embodiment. As shown in FIG. 3, the flowchart includes steps 303˜307 of usage duration/usage times mode, and steps 309˜313 of the selecting interface mode. Also, a switch step can be performed for the two modes to determine which one of the selecting interface mode and the usage duration/usage times mode is used. The flow chart of FIG. 3 is elaborated as the following description.

The method starts with Step 301. In Step 303, it is determined whether the usage duration/usage times mode is selected. From Step 303, if the result is affirmative, Steps 305 to 307 are performed; if the result is negative, Steps 309 to 313 are performed. In Step 305, a most suitable program is selected. In one embodiment, this step is selecting a program with a maximum display times or a maximum display duration. In Step 307, the most suitable program is displayed. In Step 309, it is determined whether “My Favorite mode (selecting interface) is selected. From Step 309, if the result is affirmative, Steps 311 to 313 are performed; if the result is negative, Step 315 is performed. In Step 311, the selecting interface is displayed, and a program is selected via the selecting interface. In Step 313, the program selected in Step 311 is displayed. The method ends at Step 315.

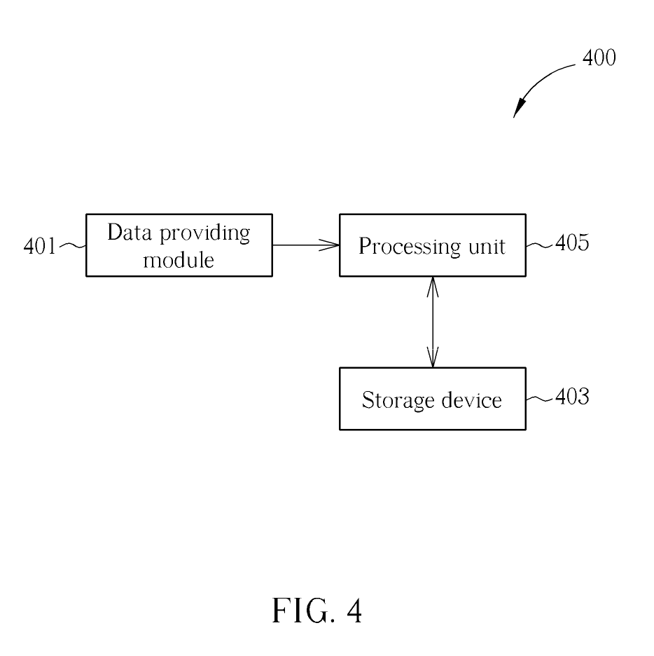

FIG. 4 illustrates a system corresponding to the first embodiment and the second embodiment of the present invention. A data processing system 400 comprises a data providing module 401, a storage device 403 and a processing unit 405. For the first embodiment, the data providing module 401 is a circuit or a system providing TV data, but can also be a circuit or a system providing another type of data source. The storage device 403 is for storing a usage time parameter or a usage times parameter. Apart from being for displaying the TV data, the processing unit 405 further performs at least one of the following two steps: recording the usage duration of the TV data channel in a predetermined time period of at least one day to generate a usage time parameter; recording usage times of the TV data channel in a predetermined time period of at least one day to generate a usage times parameter. Additionally, the processing unit 405 provides a selecting interface for selecting channels to be displayed according to the usage time parameter or the usage times parameter.

For the second embodiment, the data providing module 401 is a circuit or a system providing TV data, but can also be a circuit or a system providing another type of data. The storage device 403 is for storing a usage time parameter or a usage times parameter. Apart from being for displaying the TV data, the processing unit 405 further performs at least one of the following two steps: recording usage duration of the TV data channel in a predetermined time period of at least one day to generate a usage time parameter; recording usage times of the TV data channel in a predetermined time period of at least one day to generate a usage times parameter. Additionally, the processing unit 405 displays the TV data according to the usage time parameter or the usage times parameter when displaying the TV data in the predetermined time period of any one day. Alternatively, the processing unit 405 records the usage times of a TV data at a predetermined time point in at least one day to generate the usage times parameter, and displays the TV data according to the usage times parameter when displaying TV data at the predetermined time point of any one day. Furthermore, as above-mentioned, the system shown in FIG. 4 can be utilized for data besides TV data, and such applications also fall within the scope of the present invention.

According to the above-mentioned embodiment, data can be automatically processed or a selecting interface can be selected according to the usage duration and/or the usage times, thereby the convenience of a user can be enhanced.

Those skilled in the art will readily observe that numerous modifications and alterations of the device and method may be made while retaining the teachings of the invention.

What is claimed is:

1. A data processing method, comprising:
(a) respectively recording usage duration and/or the number of usage times of a plurality of data in a predetermined time period of at least one day to generate a usage parameter; and
(b) processing the data according to the usage parameter in the predetermined time period of any one day.

2. The data processing method of claim 1, wherein the usage parameter comprises a usage time parameter and a usage times parameter, the usage time parameter is generated according to the usage duration, and the usage times parameter is generated according to the number of usage times.

3. The data processing method of claim 2, being used for a TV system, wherein the data is TV data, the usage time parameter or the usage times parameter is generated according to channel information of the TV data, and the step (b) displays the TV data in the predetermined time period of any one day according to the usage time parameter or the usage times parameter.

4. The data processing method of claim 2, being used for a music playing system, wherein the data is music data, and the step (b) plays the music data in the predetermined time period of any one day according to the usage time parameter or the usage times parameter.

5. The data processing method of claim 2, wherein the step (b) processes a data having the maximum usage duration or usage times.

6. The data processing method of claim 2, further comprising providing a selecting interface for selecting the data to be processed according to the usage time parameter or the usage times parameter.

7. The data processing method of claim 2, further comprising a switch step for determining which one of steps below is performed: providing the selecting interface for selecting the data to be selected according to the usage time parameter or the usage times parameter; and processing the data according to the usage time parameter or the usage times parameter.

8. A data processing method, comprising:
(a) respectively recording usage times of a plurality of data at a predetermined time point in at least one day to generate a usage times parameter;
(b) processing the data according to the usage times parameter at the predetermined time point of any one day.

9. The data processing method of claim 8, being used for a TV system, wherein the data is TV data, the usage times parameter is generated according to channel information of the TV data, and the step (b) displays the TV data at the predetermined time point of any one day according to the usage times parameter.

10. The data processing method of claim 8, being used for a music playing system, wherein the data is music data, and the step (b) plays the music data at the predetermined time point of any one day according to the usage times parameter.

11. The data processing method of claim 8, wherein the step (b) processes a data having the maximum usage times among the data.

12. The data processing method of claim 8, further comprising providing a selecting interface for selecting the data to be processed according to the usage times parameter.

13. The data processing method of claim 12, further comprising a switch step for determining which one of steps below is performed: providing the selecting interface for selecting the data to be selected according to the usage times parameter; and processing the data according to the usage times parameter.

14. A data processing system, comprising:
a data providing module, for providing a plurality of data;
a storage device, for storing a usage time parameter or a usage times parameter; and
a processing unit, coupled to the data providing module and the storage device, for processing the data, recording usage duration of the data in a predetermined time period of at least one day to generate the usage time parameter; recording usage times of the data in a predetermined time period of at least one day to generate the usage times parameter; and
processing the data according to the usage time parameter or the usage times parameter in the predetermined time period of any one day.

15. The data processing system of claim 14, wherein the data providing module provides TV data, the usage time parameter or the usage times parameter is generated according to channel information of the TV data, and the processing unit displays the TV data in the predetermined time period of any one day according to the usage time parameter or the usage times parameter.

16. The data processing system of claim 14, wherein the data providing module provides music data, and the processing unit plays the music data in the predetermined time period of any one day according to the usage time parameter or the usage times parameter.

17. The data processing system of claim 14, wherein the processing unit processes a data that has the maximum usage duration or usage times among the data.

18. The data processing system of claim 14, wherein the processing unit further provides a selecting interface for selecting the data to be processed according to the usage time parameter or the usage times parameter.

19. The data processing system of claim 18, wherein the processing unit further utilizes a switch step for determining which one of steps below is performed: providing the selecting interface for selecting the data to be selected according to the usage time parameter or the usage times parameter; and processing the data according to the usage time parameter or the usage times parameter.
